(19) United States
(12) Patent Application Publication
(10) Pub. No.: US 2024/0380280 A1
(43) Pub. Date: Nov. 14, 2024

(54) THERMAL CIRCUIT FOR A BATTERY-ELECTRIC MOTOR VEHICLE

(71) Applicant: Dr. Ing. h.c. F. Porsche Aktiengesellschaft, Stuttgart (DE)

(72) Inventors: Fabian ZEYHER, Stuttgart (DE); Tobias RAPP, Weissach (DE)

(21) Appl. No.: 18/655,370

(22) Filed: May 6, 2024

(30) Foreign Application Priority Data
May 10, 2023 (DE) 10 2023 112 262.2

(51) Int. Cl. H02K 9/19; B60H 1/00; B60H 1/22; B60L 50/60; B60L 58/24; H01M 10/613; H01M 10/615; H01M 10/625; H01M 10/6568; H01M 10/657

(52) U.S. Cl. CPC H02K 9/19; B60H 1/00278; B60H 1/00392; B60H 1/2215; B60L 50/60; B60L 58/24; H01M 10/613; H01M 10/615; H01M 10/625; H01M 10/6568; H01M 10/657; H01M 2220/20

(57) ABSTRACT

A thermal circuit for a battery-electric motor vehicle including a first partial circuit for a high-voltage battery, a second partial circuit for a chiller, a third partial circuit for at least one electric drive machine, and a fourth partial circuit for an air conditioner of a refrigerant circuit for a transport compartment. Each partial circuit includes a pump and a temperature control medium circulated therein can be circulated within a respective partial circuit sealed off from at least one of the other partial circuits. At least two of the partial circuits can be connected to each other in a mixable manner by at least one mixing valve.

### CROSS REFERENCE TO RELATED APPLICATIONS

This application claims benefit to German Patent Application No. 10 2023 112 262.2, filed on May 10, 2023, which is hereby incorporated by reference herein.

### FIELD

The invention relates to a thermal circuit for a battery-electric motor vehicle, as well as a motor vehicle with such a thermal circuit with an electrified drive.

### BACKGROUND

From the prior art, thermal circuits for thermal management systems for an electrified motor vehicle are known. Due to the high efficiency of the electrical components, significantly less waste heat is generated in an electrified motor vehicle compared to components from conventional combustion engine-powered motor vehicles. In addition, the temperature ranges in which the components can be operated are significantly smaller compared to the components from a combustion engine-powered vehicle, which is why the functional requirements for thermal circuits have increased significantly. Due to the high efficiency, not enough heat energy from waste heat is available for the temperature control of the passenger cabin in cold ambient temperatures. This lack of thermal energy is therefore generated using electric heaters or heat pumps powered by electrical energy from a high voltage battery. The problem here is that this reduces the range of the electrified vehicle.

### SUMMARY

In an embodiment, the present disclosure provides a thermal circuit for a battery-electric motor vehicle comprising a first partial circuit for a high-voltage battery, a second partial circuit for a chiller, a third partial circuit for at least one electric drive machine, and a fourth partial circuit for an air conditioner of a refrigerant circuit for a transport compartment. Each partial circuit comprises a pump and a temperature control medium circulated therein can be circulated within a respective partial circuit sealed off from at least one of the other partial circuits. At least two of the partial circuits can be connected to each other in a mixable manner by at least one mixing valve.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a thermal circuit in a switching diagram; and

FIG. 2 illustrates a motor vehicle having a thermal circuit.

### DETAILED DESCRIPTION

In an embodiment, the present invention provides a thermal circuit that that overcomes the foregoing disadvantages of the prior art. The features described in the present disclosure can be combined in any technically meaningful manner, for which purpose it is also possible to consult the explanations from the following description and features from the figures, which comprise additional configurations of embodiments of the invention.

An embodiment of the invention relates to a thermal circuit for a battery-electric motor vehicle, comprising at least the following components:
a first partial circuit for a high-voltage battery;
a second partial circuit for a chiller;
a third partial circuit for at least one electric drive machine; and
a fourth partial circuit for an air conditioning device of a refrigerant circuit for a transport compartment,
   wherein each partial circuit comprises a pump and a temperature medium circulated therein can be circulated within a respective partial circuit sealed off from at least one of the other partial circuits.

The thermal circuit is characterized in particular in that at least two of the partial circuits can be connected to each other in a mixable manner by means of the at least one mixing valve.

Unless explicitly stated otherwise, ordinal numbers are used in the preceding and the following description only for the purposes of clear distinction and do not reflect any order or ranking of the designated components. An ordinal number greater than one does not imply that another such component has to necessarily be present.

The thermal circuit described herein comprises a plurality of units that exchange heat with each other by means of the partial circuits. This makes a wide variety of heat sources or cold sources accessible or usable. However, the problem here is that the heat output or the heat capacities are not matched to one another as with a direct assignment of a unit and a (for example air) heat exchanger. With the thermal circuit disclosed herein, this problem is solved by switching at least one mixing valve between two partial circuits. Thus, a volume flow of one partial circuit can be proportionally mixed with the volume flow of another partial circuit, preferably continuously variable. Thus, a temperature in a partial circuit can be set in a suitable manner without the temperature in the other partial circuit having to be identical. In this context, it should be noted that a heat conversion or a heat output takes place exclusively when a temperature gradient is set. The desired heat output can thus be easily controlled or regulated via the mixing ratio.

The first partial circuit is provided for tempering the high-voltage battery and comprises a first pump. A homogeneous temperature distribution in the high-voltage battery is desired here. This can be achieved by a low temperature gradient between the temperature control medium and the high-voltage battery, as well as by repeated circulation of the temperature control medium without (inevitably) allowing heat to be transferred to other units. Rather, to homogenize the temperature distribution in the high-voltage battery, the heat is transferred from one or more regions or cells of the high-volt battery to one or more other regions or cells of the high-voltage battery. This process can also be superimposed with cooling or heating by means of externally supplied heat output. To this end, a circulation completed by another partial circuit, i.e., a closed circulation, is advantageous.

The second partial circuit is provided for receiving cold or heat of a chiller and comprises a second pump. It is desirable here to only operate the chiller for a specific time and/or to set a specific temperature, or to generate a greater temperature gradient than is possible with the chiller used when the temperature control medium passes through. Closed circulation is also advantageous for this purpose.

The third partial circuit is provided for tempering the at least one electric drive machine and comprises a third pump. It should be noted that in an embodiment, the third partial circuit again comprises a number of partial circuits corresponding to the number of electric drive machines, for example. Preferably, a single circuit is preferably provided, in which the flow rate can preferably be switched off and/or throttled via at least one of the electric drive machines. A high cooling output with a high torque demand or a high mechanical power demand and thus a high consumption of electrical power current is desired here. Furthermore, a pulse inverter (for example, separately associated with a respective electric drive machine) and/or a step-up converter for converting a (too) low electrical (input) voltage into a needs-based electrical (output) voltage are preferred here. In an advantageous embodiment, an expansion tank is arranged in the third partial circuit to relieve the pressure in the event of volume changes, for example due to the thermal expansion of the temperature control medium. Irrespective of the foregoing, an air heat exchanger, preferably with a channel closure (for example a louvre) and/or with a fan, is also preferably provided for heat exchange with the ambient air. With closed circulation in the third partial circuit, for example, a conventional temperature control operation can be executed for tempering the at least one electric drive machine.

The fourth partial circuit is provided for receiving cold or heat of a refrigerant circuit for an air conditioning device and/or via the air flow into the transport compartment, for example a passenger cabin and/or a cargo compartment, for receiving cold or heat directly from the air conditioning device. The waste heat can be received in the transport compartment, but conversely the (too) cold transport compartment can also be heated using waste heat from the fourth partial circuit. The fourth partial circuit also comprises its own (fourth) pump. With closed circulation in the fourth partial circuit, for example, the temperature of the temperature control medium in the fourth partial circuit can be changed further than is possible in a single run. Closed circulation is also advantageous for this purpose.

It should be noted that fluidic separation is not mandatory for closed circulation. Rather, throttling and/or a different flow rate in the respective partial circuits (which are generally open to each other) is sufficient. Preferably, this can be set directly (as a closure) or indirectly (via throttling effects) by means of a relevant mixing valve.

As indicated above, at least two of the partial circuits can now be connected to each other by means of a mixing valve in metered doses. This means that the temperature control medium at a current temperature is not (inevitably) replaced by an inflowing temperature control medium at a different temperature. Rather, a mixture of two inflow openings (namely from the partial circuit currently under consideration and a partial circuit providing or requesting heat output) is discharged into an outflow opening, wherein a certain temperature of the temperature control medium mixed at the outflow opening is set and thus a heat output is set via the respective volume flow.

In a preferred embodiment, each mixable partial circuit is provided with a mixing valve.

Preferably, a mixing valve comprises one, particularly preferably two, inflow openings and two outflow openings. In an embodiment with four openings, two inflow openings can be connected to only one single outflow opening at a time (in different adjustable ratios).

In an embodiment, closed circulation is performed in a partial circuit with a mixing valve closed to the partial circuit in question by means of conduction via a corresponding bypass.

Furthermore, in an advantageous embodiment of the thermal circuit, it is further provided that the partial circuits that can be mixed with each other share at least one of the following units:
the chiller of the second partial circuit;
an air heat exchanger;
an expansion tank; and
an electric heating element.

In this embodiment, the number of units is significantly reduced compared to previously known embodiments in that they can be used multiple times. In an embodiment, due to the multiple use, a larger dimensioned and yet economically shared unit can be used based on at least one of the partial circuits (or the units to be tempered contained therein). Alternatively, a smaller and thus more economical unit can be used compared to conventionally dimensioning of such a unit, because it can be used more efficiently for one partial circuit or (if required, simultaneously for several) as a result of closed circulation with an increased temperature gradient that can be generated (see explanation above).

The chiller is a complex unit that needs to be precisely controlled. The aim is therefore to keep costs low by using this unit only once. The air heat exchanger is relevant for the wind resistance coefficient (the so-called c_{W} value). The aim is to arrange one of these with the optimum possible arrangement with regard to the induced flow resistances. Due to its function of compensating for volume fluctuations, an expansion tank is often structurally very large, but the volume fluctuations are not as large, as this would have a significant impact on the overall size of the connected partial circuits. The electric heating element is above all an ad-hoc usable unit for causing a temperature increase. At the same time, the generation of heat from electrical power is not desired because it negatively affects the achievable range of the motor vehicle as it directly competes with the propulsion power. This unit should therefore be small in size and at the same time made available to any unit to be heated in any design condition.

It is further provided in an advantageous embodiment of the thermal circuit that the first partial circuit or the second partial circuit or a connection section between the first partial circuit and the second partial circuit further comprises:
an electric heating element; and/or
an on-board charger.

In a first embodiment, it is provided that the first partial circuit comprises the abovementioned further units. This ensures that the high-voltage battery (in the first partial circuit), which on the one hand is a source of a high heat output during operation, and on the other hand should not be too cold for a good range, i.e., can also receive a great deal of heat output under certain circumstances, can use the waste heat of the electric heating element and/or the on-board charger. In a second embodiment, it is provided that the second partial circuit comprises the abovementioned further units. This ensures that the chiller (in the second partial circuit) is thus configured to cool the on-board charger or to provide the heat output to one or more other units via its cooling process.

In the third embodiment, it is provided that a connection section between the first partial circuit and the second partial circuit comprises the abovementioned further units. The above advantages are thus achieved, which can also be used simultaneously, above all by mixing the temperature control medium of the various partial circuits.

It is further provided in an advantageous embodiment of the thermal circuit that the temperature control medium is a dielectric liquid and at least one of the following units is immersion-tempered:
the high-voltage battery;
the at least one electric drive machine;
at least one pulse inverter for one of the drive machines;
an OnBoardCharger; and
a step-up converter.

The advantage of immersion tempering, i.e., the direct contact between the temperature control medium and (potentially) electrically conductive and/or magnetically conductive components, is the direct heat transfer between the component or unit to be cooled and the temperature control medium, without the need for a partition wall and/or a separate circuit.

However, what is also special here is that the immersion tempering is not only used for one type of unit (for example exclusively for the high-voltage battery or exclusively for the electric drive machine), but is used together for several, therefore different units. This creates a particularly efficient heat conversion, i.e., the utilization of the waste heat or the cold of other units within the motor vehicle. In a preferred embodiment, all of the abovementioned units and optionally further units in the thermal circuit are tempered together by a single temperature control medium, preferably immersion-tempered.

Furthermore, in an advantageous embodiment of the thermal circuit, it is provided that the chiller interacts with the refrigerant circuit for a transport compartment for re-tempering, preferably closed, and the refrigerant circuit is in air-heat exchange with the fourth partial circuit for the air conditioning device of the transport compartment.

The chiller has a first side and a second side, wherein in an embodiment the heat transfer direction (i.e., exclusively cooling of the first side and heating the second side, or vice versa) is fixed, preferably the heat transfer direction is reversible. On the first side, the second partial circuit is in direct heat exchange and on the second side, the refrigerant circuit is in direct immediate heat exchange. A cold process is performed in the chiller, wherein the material-bonded (casually: internal) energy (for example, by means of expansion, evaporation, evaporation or absorption) of the circulated active heat transfer medium is utilized. In an embodiment, the refrigerant of the refrigerant circuit is always passed through the second side of the chiller in the liquid state. Preferably, all circuits involved in the chiller are closed, i.e., one heat transfer medium is in contact with the other heat transfer medium for heat exchange, separated from each other only by a partition wall.

Furthermore, in an advantageous embodiment of the thermal circuit, it is provided that at least two of the following operating states and a mixing of the partial circuits according to the individual operating states can be set by means of a first of the mixing valves:
a closed first partial circuit exclusively via the high-voltage battery;
a closed first partial circuit exclusively via the high-voltage battery and an electric heating element, and preferably an on-board charger; and
a common circuit of the first partial circuit and the second partial circuit, preferably in interaction with a second of the mixing valves.

It should be noted that several operating states can also be set at the same time (if this makes sense technically or with regard to the definition here), wherein the respective partial circuits or their temperature control medium are then mixed. In an embodiment, a common circuit with a further partial circuit can be set (additionally or alternatively), preferably by means of one or more further mixing valves and/or indirectly via the second partial circuit or a further partial circuit.

It should be noted that in an operating state in which two or more mixing valves interact, they must each be set accordingly at the same time. For example, to form a common circuit from the first partial circuit and the second partial circuit, both partial circuits are not closed. For an operating state of a closed common circuit consisting exclusively of the first partial circuit and the second partial circuit (and, for example, the electric heating element and/or on-board charger, for example arranged in a connection section), both partial circuits are closed with respect to the other partial circuits (by means of the respective mixing valves). For an operating state of a closed common circuit consisting exclusively of the first partial circuit, the second partial circuit and one or a plurality of further partial circuits (and, for example, units arranged in a connection section), the partial circuits involved are closed with respect to the other partial circuits (by means of the respective mixing valves).

It should be noted that an operating state with a set common circuit does not necessarily mean that the temperature control medium is directed via all involved partial circuits with the same flow rate and the same temperature. Rather, mixing is also possible and, if necessary, a preferred operating state for very different requirements of the units of the respective partial circuits.

It should be noted that the temperature control medium of the interconnectable partial circuits is identical with respect to the substance used. However, (depending on the operating state) a current volume flow (via the respective pump) and/or a current temperature is different. In this respect, the term here refers to a temperature control medium of a specific partial circuit.

Furthermore, in an advantageous embodiment of the thermal circuit, it is provided that at least two of the following operating states and a mixing of the partial circuits according to the individual operating states can be set by means of a second of the mixing valves:
a closed second partial circuit exclusively via the chiller;
a closed second partial circuit exclusively via the chiller and an electric heating element, and preferably an on-board charger; and
a common circuit of the first partial circuit and the second partial circuit, preferably in interaction with a first of the mixing valves.

For an explanation, reference is made here to the description of the first mixing valve and its operating states analogously or overlapping.

Furthermore, in an advantageous embodiment of the thermal circuit, it is provided that at least two of the following operating states and a mixing of the partial circuits according to the individual operating states can be set by means of a third of the mixing valves:
a closed third partial circuit exclusively via the at least one electric drive machine, and preferably further components of the drive;
a closed third partial circuit exclusively via the at least one electric drive machine, and preferably further components of the drive, and an air heat exchanger; and
a common circuit of the third partial circuit with the first partial circuit and/or the second partial circuit, preferably in interaction with a first of the mixing valves and with a second of the mixing valves.

For an explanation, reference is made here to the description of the first mixing valve and its operating states analogously or overlapping. Further components of the drive include, for example, power electronics, a (preferably respective) pulse inverter for an electric drive machine, a step-up converter, and/or a (preferably axis-separate) transmission oil cooling. The air heat exchanger is configured to temper the temperature control medium using ambient air conveyed passively and/or actively (via fan). Preferably, this is an air heat exchanger used together with the other partial circuits, particularly preferably the only air heat exchanger in the thermal circuit.

It is further provided in an advantageous embodiment of the thermal circuit, that by means of a fourth of the mixing valves at least one of the following operating states and a mixing of the partial circuits according to the individual operating states can be set:
a closed fourth partial circuit exclusively via the air conditioning device, and preferably an internal condensation exchanger to the refrigerant circuit of the air conditioning device for the transport compartment; and
a common circuit of the fourth partial circuit with the third partial circuit.

For an explanation, reference is made here to the description of the first mixing valve and its operating states analogously or overlapping. The internal or indirect condensation exchanger is configured to transfer the heat from the refrigerant-side condensation performance to the temperature control medium in the fourth partial circuit. This means that both the waste heat and the cold (e.g., via the air-heat exchange in the vaporizer of the refrigerant circuit) are particularly efficiently made available for the thermal circuit.

It should be noted that the fourth partial circuit can preferably only be connected to the third partial circuit and possibly only indirectly via the third partial circuit to the first partial circuit and/or the second partial circuit to form a common circuit. Alternatively or additionally, the fourth partial circuit can alternatively or additionally be directly connected to the first partial circuit and/or the second partial circuit to form a common circuit.

According to a further aspect, a motor vehicle with an electrified drive is provided, comprising a transport compartment and a thermal circuit according to an embodiment according to the above description for tempering the electrified drive and the transport compartment,

wherein the electrified drive comprises at least the following components:
at least one electric drive machine;
at least one high-voltage battery for supplying an electrical power current to the at least one electric drive machine; and
at least one propulsion wheel for propelling the motor vehicle by means of a torque output of the at least one electric drive machine.

The motor vehicle is provided for transporting at least one passenger and/or goods and comprises a transport compartment, for example a passenger compartment and (alternatively or additionally, as well as separately or jointly) a cargo compartment. The motor vehicle is driven via the at least one propulsion wheel by means of the torque of at least one of the electric drive machines. For this purpose, the torque of the respective electric drive machine is transferable via a transmission to at least one propulsion wheel. The at least one propulsion wheel is configured so as to drive the motor vehicle forward. The tempering of the units of the drive and the transport compartment is performed by a thermal circuit and a refrigerant circuit according to an embodiment according to the above description.

It should be noted that a plurality of different operating states are described herein or at least implicitly disclosed, which comprise suitable methods for tempering (thermal management) of units of the drive and the transport compartment of a motor vehicle. Preferably, the method is controlled or can be executed (with the aid of at least one suitable sensor, such as a temperature sensor and/or valve position sensor) by a controller for thermal management. Input variables are (as a non-exhaustive list) an inhomogeneity of a temperature distribution in one unit, a temperature range of a unit to be observed, a compromise of temperature ranges of several units to be observed in the same partial circuit or several partial circuits, and a pre-conditioning (for example, colder than currently necessary) for a pending performance query (for example, for the racing operation of the vehicle).

The above-described embodiments are discussed in detail in the following in the context of the relevant technical background with reference to the accompanying drawings which show preferred embodiments. The invention is not limited in any way by the purely schematic drawings, whereby it should be noted that the drawings are not true to scale and are not suitable for defining dimensional relationships. The figures show:

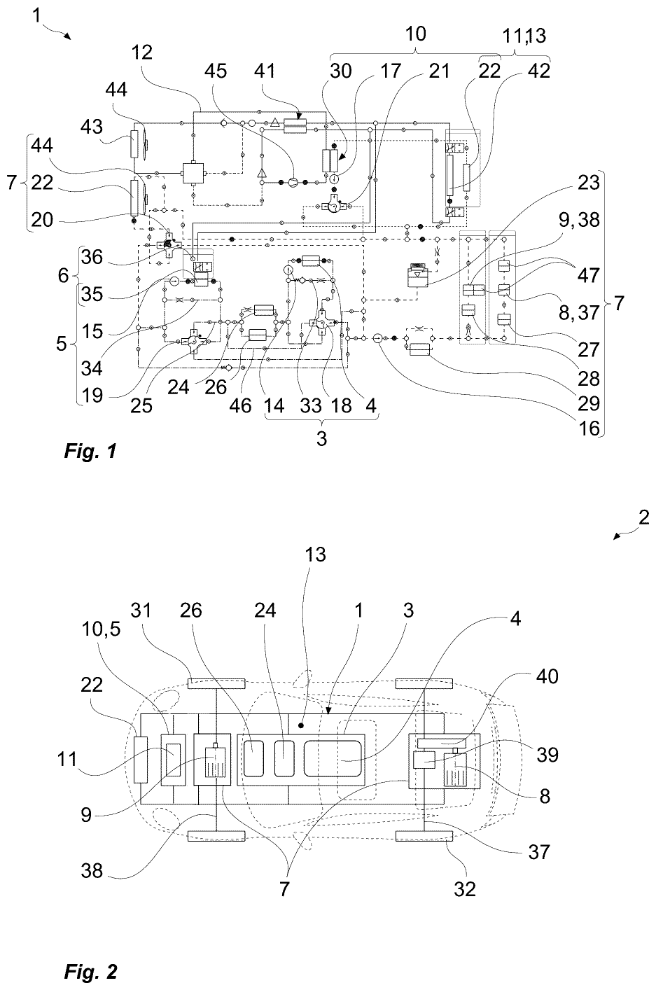

In FIG. 1, a thermal circuit 1 is shown in a schematic circuit diagram for a motor vehicle 2. In this example embodiment, the thermal circuit 1 comprises four partial circuits 3,5,7,10 and a plurality of units, which are in heat exchange with each other by means of the partial circuits 3,5,7,10 and through which a temperature control medium flows. The flow directions in the line sections are indicated by arrows. Intersecting line sections are not fluidically connected to each other, but only T-junctions with a point are fluidic connections. Furthermore, a plurality of (preferably purely temperature) sensors [points on the line sections], chokes [mirrored bends tangential to the line sections] and check valves [pre-stressed ball body in sealing position] are shown, which are arranged at an appropriate location.

The first partial circuit 3 is provided for tempering a high-voltage battery 4 and also comprises a first pump 14. To homogenize the temperature distribution in the high-voltage battery 4, the heat is transferred from one or more regions or cells of the high-voltage battery 4 to one or more other regions or cells of the high-voltage battery 4. This process can also be superimposed with cooling or heating by means of an externally supplied heat capacity (or cooling capacity). For this purpose, circulation closed off by another partial circuit 5,7,10, i.e., a closed circulation, is advantageous.

In addition, the first partial circuit 3 comprises a first mixing valve 18, which is configured to mix the temperature control medium and to adjust the desired temperature within a partial circuit 3,5,7,10 or the corresponding units of the thermal circuit 1.

As shown, an on-board charger 26 is arranged to the left of the high-voltage battery 4, which is configured to charge the high-voltage battery 4, and a heating element 24 is arranged below the on-board charger 26. The heating element 24 is configured to heat the high-voltage battery 4, wherein the operation of the heating element 24 results in a reduction of the range of the motor vehicle 2. Both the on-board charger 26 and the heating element 24 are arranged within a connection section 25 between the first partial circuit 3 and the second partial circuit 5. Furthermore, the (extended) first partial circuit 3 comprises an extension section 46, via which the temperature control medium can be circulated in the (extended) first partial circuit 3, so that the heat output of the electric heating element 24 and/or the on-board charger 26 can be made available solely and quickly to the high-voltage battery 4 or, conversely, the cold of the high-voltage battery 4 can be made available solely and quickly to the on-board charger 26.

The second partial circuit 5 is provided for receiving cold or heat of a chiller 6 and also comprises a second pump 15 and a second mixing valve 19. The chiller 6 has a first side 35 and a second side 36, wherein preferably the heat transfer direction is reversible. On the first side 35, the second partial circuit 5 is in direct heat exchange and on the second side 36, the refrigerant circuit 12 is in direct heat exchange.

In this example embodiment, closed circulation is performed in the partial circuits 3,5 with mixing valves 18,19 closed with respect to the relevant partial circuits 3,5 by means of conduction via corresponding bypasses 33,34.

The third partial circuit 7 is provided for tempering (only optionally two) electric drive machines 8, 9 and also comprises a third pump 16 and a third mixing valve 20. For example, the first drive machine 8 is arranged on a rear axle 37 and the second drive machine 9 is arranged on a front axle 38 of the motor vehicle 2 (see FIG. 2). The drive also comprises a first pulse inverter 27 or a second pulse inverter 28 and advantageously a device for transmission oil cooling 47, as well as a (optional) step-up converter 29 (also referred to as a combined boost converter).

In this example embodiment, the third partial circuit 7 also comprises an expansion tank 23, which is configured to be relieved during volume changes, for example due to the thermal expansion of the temperature control medium. Independent of this, an air heat exchanger 22 is further provided for heat exchange with the ambient air, shown here purely as an option with an active fan 44. With closed circulation in the third partial circuit 7, for example, a conventional temperature control operation can be executed for tempering the at least one electric drive machine 8,9.

The fourth partial circuit 10 is provided for receiving cold or heat of a refrigerant circuit 12 for an air conditioning device 11 and/or via the air flow into the transport compartment 13 of a motor vehicle 2 (see FIG. 2) directly at or in the air conditioning device 11 of the refrigerant circuit 12. By means of the fourth partial circuit 10, the waste heat can be received in the transport compartment 13, but conversely the (too) cold transport compartment 13 can be heated using waste heat from the fourth partial circuit 10. The fourth partial circuit 10 also comprises its own (fourth) pump 17 and a mixing valve 21. A vaporizer 42 is provided within the air conditioning device 11. Furthermore, an indirect condensation exchanger 30 is provided, which is configured to transfer the heat from the refrigerant-side condensation performance in the refrigerant circuit 12 with the temperature control medium in the fourth partial circuit 10.

It should be noted that the refrigerant circuit 12 is provided as part of the thermal circuit 1 or as a separate system. The refrigerant circuit 12 is not described in more detail herein and is designed conventionally, for example. However, reference should be made here to the units of condenser 43 with (optional) active fan 44, vaporizer 42 and compressor 45, which are mandatory for phase change-based chiller operation, as well as to the optional internal heat exchanger [IWT 41] and the aforementioned optional indirect condensation exchanger 30 for the fourth partial circuit 10.

It should be noted that fluidic separation is not mandatory for a closed circulation within the partial circuits 3,5,7,10. Rather, a throttling and/or a different flow rate in the respective partial circuits 3,5,7,10 (generally open to each other) is sufficient. This is directly (as a closure) or indirectly (via throttle effects) adjustable by means of a relevant mixing valve 18, 19, 20, 21.

For the sake of completeness, it should be noted that here two inflow openings (optional) are provided for the first mixing valve 18 (top and bottom), for the second mixing valve 19 (left and right) and for the third mixing valve 20 (top and bottom), and two outflow openings are provided in each case. The fourth mixing valve 21 has a single inflow opening (top) and two outflow openings (left and right).

FIG. 2 shows a motor vehicle 2 with a thermal circuit 1 (and, as indicated, a refrigerant circuit 12 for the transport compartment 13). The motor vehicle 2 is provided for transporting at least one passenger and/or goods and comprises a transport compartment 13 for this purpose, in this case mainly a passenger cabin, for example. The motor vehicle 2 is driven via the front drive wheels 31 and the rear drive wheels 32 by means of the torque from the respective electric drive machines 8,9, wherein a drive machine 8 is arranged on the rear axle 37 and a second drive machine 9 on the front axle 38. For this purpose, the torque of the respective electric drive machine 8,9 (with the front optionally coaxial and the rear optionally axial-parallel) can be transferred to the drive wheels 31,32 via a transmission 40 and a differential 39 (only indicated at the rear). The drive wheels 31,32 are configured to propel the motor vehicle 2. To temper the units of the drive and the transport compartment 13, a thermal circuit 1, for example as shown in FIG. 1, and the refrigerant circuit 12 for the transport compartment 13 are provided.

The thermal circuit provided here makes the complete internal use of waste heat or cold economically viable.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 1 | Thermal circuit |
| 2 | Motor vehicle |
| 3 | First partial circuit |
| 4 | High-voltage battery |
| 5 | Second partial circuit |
| 6 | Chiller |
| 7 | Third partial circuit |
| 8 | First drive machine |
| 9 | Second drive machine |
| 10 | Fourth partial circuit |
| 11 | Air conditioning device |
| 12 | Refrigerant circuit |
| 13 | Transport compartment |
| 14 | First pump |
| 15 | Second pump |
| 16 | Third pump |
| 17 | Fourth pump |
| 18 | First mixing valve |
| 19 | Second mixing valve |
| 20 | Third mixing valve |
| 21 | Fourth mixing valve |
| 22 | Air heat exchanger |
| 23 | Expansion tank |
| 24 | Heater element |
| 25 | Connection section |
| 26 | OnBoardCharger |
| 27 | First pulse inverter |
| 28 | Second pulse inverter |
| 29 | Step-up converter |
| 30 | Indirect condensation exchanger |
| 31 | Front drive wheel |
| 32 | Rear drive wheel |
| 33 | First bypass |
| 34 | Second bypass |
| 35 | First side of the chiller |
| 36 | Second side of the chiller |
| 37 | Rear axle |
| 38 | Front axle |
| 39 | Differential |
| 40 | Transmission |
| 41 | Internal heat exchanger [IWT] |
| 42 | Vaporizer |
| 43 | Capacitor |
| 44 | Fan |
| 45 | Compressor |
| 46 | Extension section |
| 47 | Transmission oil cooling |

1. A thermal circuit for a battery-electric motor vehicle, the thermal circuit comprising:
a first partial circuit for a high-voltage battery;
a second partial circuit for a chiller;
a third partial circuit for at least one electric drive machine; and
a fourth partial circuit for an air conditioner of a refrigerant circuit for a transport compartment,
wherein each partial circuit comprises a pump and a temperature control medium which is configured to be circulated by the pump within a respective partial circuit sealed off from at least one of the other partial circuits, and
wherein at least two of the partial circuits can be connected to each other in a mixable manner by at least one mixing valve.

2. The thermal circuit according to claim 1, wherein the partial circuits that can be connected to each other in a mixable manner share at least one of the following:
the chiller of the second partial circuit,
an air heat exchanger,
an expansion tank, and
an electric heating element.

3. The thermal circuit according to claim 1, wherein the first partial circuit or the second partial circuit or a connection section between the first partial circuit and the second partial circuit further comprises:
an electric heating element, and/or
an on-board charger.

4. The thermal circuit according to claim 1, wherein the temperature control medium is a dielectric liquid and at least one of the following is immersion tempered:
the high voltage battery,
the at least one electric drive machine,
at least one pulse inverter for one of the at least one drive machines,
an on-board charger, and
a step-up converter.

5. The thermal circuit according to claim 1, wherein the chiller interacts with the refrigerant circuit for the transport compartment, for retempering and the refrigerant circuit is in air-heat exchange with the fourth partial circuit for the air conditioner of the transport compartment.

6. The thermal circuit according to claim 1, wherein by a first of the at least one mixing valves, at least two of the following operating states and a mixing of the partial circuits according to the operating states can be set:
a closed first partial circuit exclusively via the high-voltage battery;
a closed first partial circuit exclusively via the high-voltage battery and an electric heating element; and
a common circuit of the first partial circuit and the second partial circuit.

7. The thermal circuit according to claim 1, wherein by a second one of the at least one mixing valves, at least two of the following operating states and a mixing of the partial circuits according to the individual operating states can be set:
a closed second partial circuit exclusively via the chiller;
a closed second partial circuit exclusively via the chiller and an electric heating element; and
a common circuit of the first partial circuit and the second partial circuit.

8. The thermal circuit according to claim 1, wherein, by a third one of the at least one mixing valves, at least two of the following operating conditions and a mixture of the partial circuits according to the individual operating conditions can be set:
a closed third partial circuit exclusively via the at least one electric drive machine;
a closed third partial circuit exclusively via the at least one electric drive machine and an air heat exchanger; and
a common circuit from the third partial circuit to the first partial circuit and/or the second partial circuit.

9. The thermal circuit according to claim 1, wherein by a fourth of the at least one mixing valves at least one of the following operating states and a mixing of the partial circuits according to the individual operating states can be set:
a closed fourth partial circuit exclusively via the air conditioner; and
a common circuit of the fourth partial circuit with the third partial circuit.

10. A motor vehicle having an electrified drive, comprising a transport compartment and the thermal circuit according to claim 1 for tempering the electrified drive and the transport compartment,
wherein the electrified engine comprises:
at least one electric drive machine;
at least one high-voltage battery for supplying an electrical power current to the at least one electric drive machine; and
at least one propulsion wheel for propelling the motor vehicle using a torque output of the at least one electric drive machine.
